(19) United States
(12) Patent Application Publication
(10) Pub. No.: US 2026/0340049 A1
(43) Pub. Date: Oct. 29, 2026

(54) METHOD FOR GENERATING A DATABASE QUERY BASED ON WEB CONTENT ANALYSIS

(71) Applicant: EAZYPATENT LIMITED LIABILITY COMPANY, MOSCOW (RU)

(72) Inventors: Artem Aleksandrovich KRAVCHENKO, Moscow (RU); Maksim Andreevich CHERNYAEV, Moscow (RU)

(21) Appl. No.: 19/234,291

(22) Filed: Jun. 11, 2025

(30) Foreign Application Priority Data
Apr. 24, 2025 (RU) 2025110699

(51) Int. Cl. G06F 16/9532

(52) U.S. Cl. CPC G06F 16/9532

(57) ABSTRACT

The proposed solution relates to computer technology, particularly to methods for automatic database query generation based on web content analysis. The problem to be solved by the claimed invention is automatic generation of an accurate database query for comparing items presented on an external resource against the International Classification of Goods and Services (Nice Classification) stored in a database. The objective is to improve the accuracy of queries to the database that stores the Nice Classification based on automated analysis of items on an external resource. The objective is achieved by a method for generating a database query, which is performed by a processor of a computer device, based on web content analysis and extracting of embedded entries from the hierarchical structure of the analyzed web content.

### FIELD OF INVENTION

The proposed solution relates to computer technology, particularly to methods for automatic database query generation based on web content analysis.

### Description of the Related Art

There is a known method for analyzing similarities of goods and services in order to predict confusions between trademarks (WO2024177678, 08/29/2024). The known solution uses a machine learning model that analyzes classifications of trademarks and calculates a similarity score, providing a final result.

No solutions have been found in the prior art that are configured to automatically generate a query to a database with marked up goods and services, based on processing a link to an external resource containing descriptions of the goods and/or services to be classified and compared against the International Classification of Goods and Services (Nice Classification).

### SUMMARY OF THE INVENTION

The problem to be solved by the claimed invention is automatic generation of an accurate database query for comparing items presented on an external resource against the International Classification of Goods and Services (Nice Classification) stored in a database.

The objective is to improve the accuracy of queries to the database that stores the Nice Classification based on automated analysis of items on an external resource.

Additionally, the invention serves to expand the technical means used to automatically generate database queries.

Another objective is to automatically generate a list of goods and services based on analyzing information about the items on the list on an external resource and identifying items that match those on the list in order to generate a resulting list of goods and services.

The objectives are achieved by a method for generating a database query, which is performed by a processor of a computer device, the method comprising the following steps:
identifying web content that contains at least one heading text entry, at least one attachment text entry that is hierarchically embedded in the heading text entry, and at least one end attachment text entry that is hierarchically embedded in the at least one attachment text entry;
identifying, within the end attachment text entry, at least one unique entry, and/or identifying, within the end attachment text entry, a pre-set unique entry;
   wherein, when only one unique entry is identified that matches the heading text entry, a database query is generated that contains at least an attachment text entry with an end attachment text entry embedded, in which the unique entry that matches the heading text entry has been identified, and/or contains a unique identifier of this attachment text entry.

In an exemplary embodiment, web content is identified using a hyperlink associated with the heading text entry.

In another exemplary embodiment, a graphical user interface is generated that provides at least
a data entry area, and
a first interactive element, which, when interacted with, generates and sends a query that contains the hyperlink or its part to a database,
wherein the hyperlink or its part are generated based on data entered in the data entry area.

In another exemplary embodiment, the generated graphical user interface provides a reply area containing a generated reply to the database query in the form of a text entry containing at least one entry stored in the database.

In another exemplary embodiment, the reply in the form of a text entry contains a heading text entry.

In another exemplary embodiment, the generated graphical user interface provides a second interactive element, which, when interacted with, generates a control signal to store at least some part of the reply in the form of a text entry in a memory of a user device and/or a server.

In another exemplary embodiment, the generated graphical user interface provides a second interactive element, which, when interacted with, generates a control signal to store at least some part of the reply in the form of a text entry in a memory of a user device and/or a server.

In another exemplary embodiment, the generated graphical user interface provides a third interactive element, which, when interacted with, generates an XML file that contains at least the reply in the form of a text entry or its part stored in the memory of a user device and/or a server,
wherein the third interactive element is available only when the reply in the form of a text entry or its part is stored in the memory of a user device and/or a server.

In another exemplary embodiment, the generated graphical user interface provides a third interactive element, which, when interacted with, generates an XML file that contains at least the reply in the form of a text entry or its part stored in the memory of a user device and/or a server,
wherein the third interactive element is available only when the reply in the form of a text entry or its part is stored in the memory of a user device and/or a server.

### BRIEF DESCRIPTION OF THE DRAWINGS

FIG. 1 illustrates the general principle of the proposed solution.

FIG. 2 shows a flowchart of the claimed method for generating a database query.

FIG. 3 shows a generated graphical user interface.

FIG. 4 shows an exemplary computing device.

### DETAILED DESCRIPTION OF THE PREFERRED EMBODIMENTS

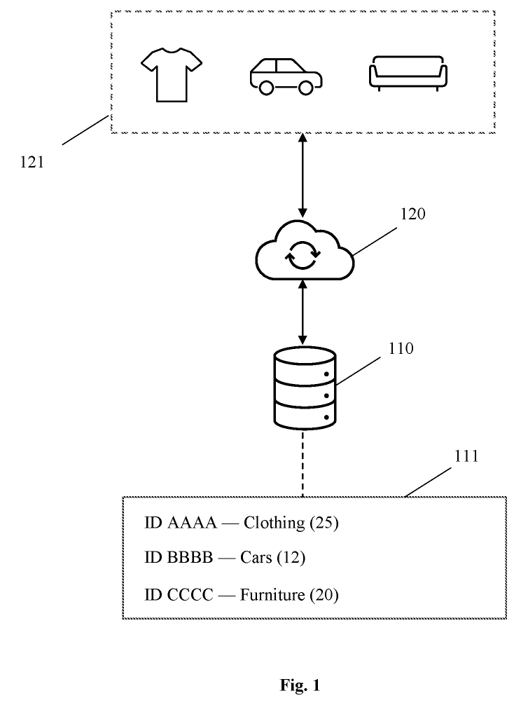

As shown in FIG. 1, the proposed solution is an automated algorithm for analyzing web content (121), e.g. web pages, web stores, online marketplaces (Ozon, WB, Yandex.Market), etc., using queries sent over the Internet (120) by means of a computing device (110) connected to a database that is used for comparing information about goods and/or services presented in web content (121), such as a web resource, on which the query to the database is based, with the information (111) stored in the database in the form of a structured classification of goods and services.

The device (110) can be a computer, a server, a computing cluster, or any other computing device capable of processing and exchanging data over a computer network in response to incoming external queries.

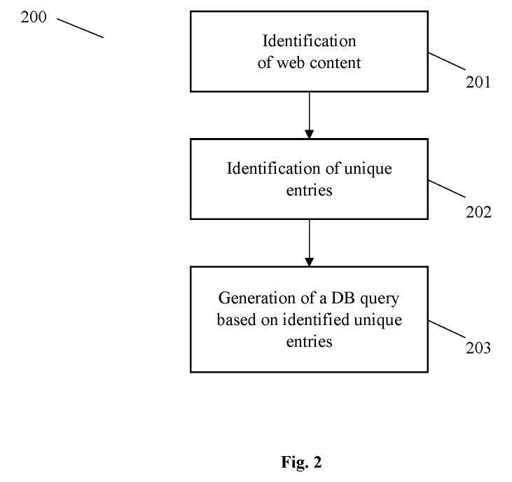

FIG. 2 shows a database query generation flowchart according to the claimed method (200). In the first step (201), web content (121) is identified, for example, a web page containing one or more heading text entries. Such entries may include, for example, the name of a store, seller, vendor of goods or services, etc. Then at least one attachment text entry that is hierarchically embedded in the heading text entry is identified, which can be the name of a product category, for example, clothing, toys, cosmetics, etc. Also, the presence of at least one end attachment text entry that is hierarchically embedded in the attachment text entry is analysed. The end attachment text entry is the name of the card of a product or service sold through the website. Web content can be accessed via an API, or using web scraping technologies, or directly via a hyperlink, etc. Web content can be identified using the hyperlink associated with the heading text entry.

Web content can be analyzed in step (201), for example, by means of processing the HTML code of the web page by extracting the necessary data from it and analyzing the hierarchy of the embedded information. Additionally, OCR technologies and machine learning models can be used to directly analyze web content.

Next, in step (202) one or more unique entries, which are part of of the end attachment text entry, are identified. A unique entry represents the lowest level in the hierarchy that allows to identify the resulting entity, which is related to web content (121). It may be either the name of a store or seller, or the name of a specific product or service.

In an exemplary embodiment, only one unique entry that matches the heading text entry can be identified when analyzing web content. This happens, for example, when the vendor of goods or services operates under their own brand (name). In this case, the unique entry will be the brand name.

In this case, a database query is generated in step (203) that contains at least an attachment text entry with an end attachment text entry embedded, in which the unique entry that matches the heading text entry has been identified, and/or contains a unique identifier of the attachment text entry. The unique identifier of the attachment text entry is an identifier of a product or service that is stored in the database.

In another exemplary embodiment, in step (202) a pre-set unique entry can be identified. This happens when web content does not contain identifiable brands. In this case, the database query in step (203) will contain a "no name", "no brand", etc. flag. In this case, specific entities characterizing goods and/or services represented in the web content will be identified.

In another exemplary embodiment, in step (202) only one unique entry that matches the heading text entry can be identified alongside at least one unique entry that is associated with a pre-set unique entry. In this case, the database query in step (203) will contain at least an attachment text entry with an end attachment text entry embedded, in which the unique entry that matches the heading text entry has been identified, and/or contain a unique identifier of this attachment text entry, and also contain at least an attachment text entry with an end attachment text entry embedded, in which the unique entry that matches the heading text entry has been identified, the entry associated with the pre-set unique entry, and/or contain a unique identifier of this attachment text entry.

In another embodiment, in step (202) at least one unique entry that does not match the heading text entry and is not associated with a pre-set unique entry can be identified. In this case, the database query in step (203) will contain at least a pre-set unique identifier of a product's or service's entry in the database. Generally, in this case, it is determined that web content contains just the information that certain products are being sold, which allows to assign such database identifiers as, for example, "retail", "third-party goods", etc.

The above method is aimed at obtaining information during the analysis of web content, which is then used as a basis for database queries, in response to which identifiers of goods and/or services represented in said web content are determined.

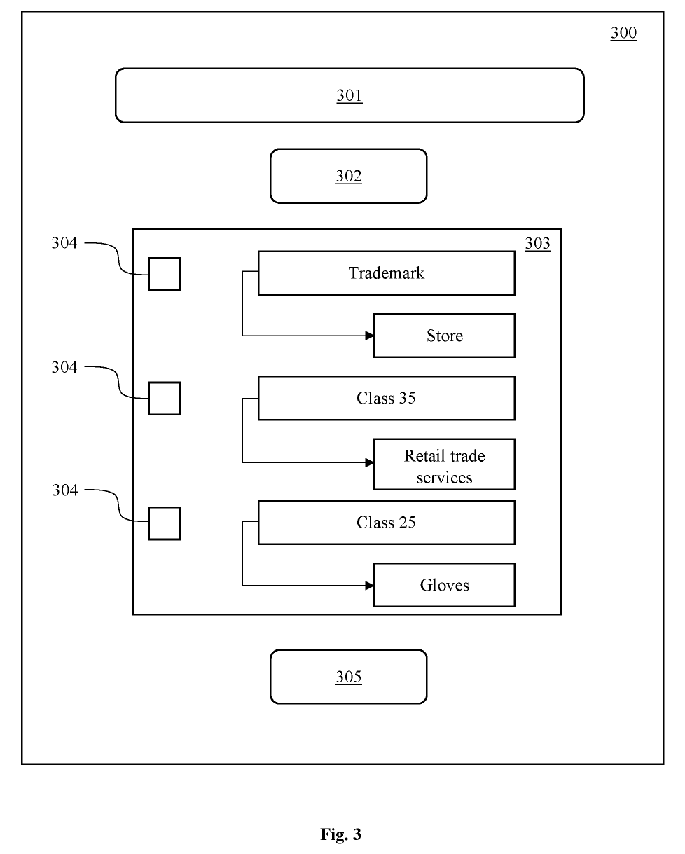

This information can be used to generate requests for trademark applications using a GUI (300), graphical user interface, illustrated by FIG. 3.

The GUI (300) can be generated so as to perform the necessary functions, such as to receive user-generated requests for activating analysis of the software logic that analyzes web content, to generate database queries, and to generate a trademark application.

The GUI contains a data entry area (301), where, for example, a hyperlink to a website can be inputted, and a first interactive element (302), which, when interacted with, generates and sends a query that contains the hyperlink or its part to a database. The hyperlink or its part are generated based on data entered in the data entry area. The area (301) is a line for inputting information.

The GUI contains a reply area (303) containing a generated reply to the database query in the form of a text entry containing at least one entry stored in the database. The reply in the form of a text entry contains a heading text entry.

The generated GUI may contain a second interactive element (304), which, when interacted with, generates a control signal to store at least some part of the reply in the form of a text entry in a memory, such as cash memory, of a user device and/or a server. The second element (304) can be represented by a checkbox that generates a signal for executing a command to store information.

The generated GUI may contain a third interactive element (305), which, when interacted with, generates an XML file that contains at least the reply in the form of a text entry or its part stored in the memory of a user device and/or a server. The third interactive element (305) is available only when the reply in the form of a text entry or its part is stored in the memory of a user device and/or a server.

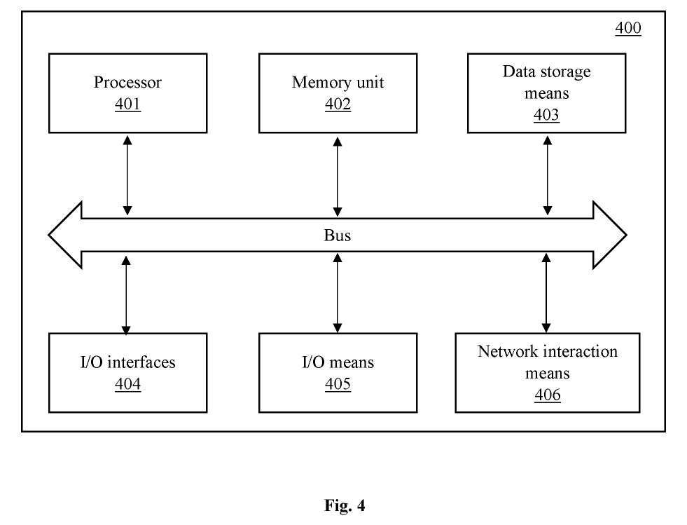

FIG. 4 shows a general example of a computing device (400), e.g. a computing unit (computing module), computer, server, laptop, smartphone, SoC (System-on-a-Chip), etc., that can be used to fully or partially implement the proposed solution, particularly to perform the steps according to the method (200) for generating a database query, as well as to generate the GUI (300).

In general terms, the device (400) comprises the following components: one or more processors (401), at least one memory unit (402), a persistent memory (403), I/O interfaces (404) including relay outputs for motion controllers of a conveyor belt, I/O means (405), and network interaction means (406).

The processor (401) of the device performs basic computations, that are necessary for the device (400) or one or more of its components to function. The processor (401) executes the necessary machine-readable instructions stored in the memory unit (402).

Generally, the memory unit (402) is a RAM (Random Access Memory) that stores program logic required for necessary functions. Persistent memory (403) may be implemented as an HDD, SDD disk, a RAID array, a network storage, a flash memory, an optical data carrier (CD, DVD, MD, Blue-Ray), etc. The memory (403) is configured for long-term storage of various data, e.g. query processing history (log), user IDs, camera footage, images etc.

The interfaces (404) are standard means for connecting and working with computing devices. The interfaces (404) can be, for example, relay connections, USB, RS232/422/485 or others, RJ45, LPT, UART, COM, HDMI, PS/2, Lightning, FireWire, etc., configured to work with Modbus protocols and Probfibus networks, among others. The choice of interfaces (404) depends on the specific design of the device (400), which may be a computing unit (computing module), for example, based on a CPU (one or more processors), a microcontroller, etc., a PC, mainframe, server cluster, thin client, smartphone, laptop, etc., as well as connected external devices.

The data I/O means (405) may include a keyboard, joystick, display (touchscreen), projector, touchpad, mouse, trackball, light pen, speakers, microphone, etc.

The network interaction means (406) are chosen from devices that are configured for receiving and transmitting data over the network, such as Ethernet board, WLAN/Wi-Fi module, Bluetooth module, BLE module, NFC module, IrDa, RFID module, GSM modem, etc. The means (406) provides exchange of data over wired or wireless data exchange channels, for example, WAN, PAN, LAN, Intranet, Internet, WLAN, WMAN or GSM, quantum data exchange channel, satellite communication, etc. As a rule, the components of the device (400) are usually coupled by means of a shared data bus.

The present disclosure refers to a preferred embodiment of the present invention, which in no way limits other possible embodiments thereof, provided that those embodiments fall within the inventive subject matter and the scope of invention, which are set forth in the following claims, and are clear to those skilled in the art.

1. A method for generating a database query that is performed by a processor of a computer device, the method comprising the following steps:
identifying web content that contains at least one heading text entry, at least one attachment text entry that is hierarchically embedded in the heading text entry, and at least one end attachment text entry that is hierarchically embedded in the at least one attachment text entry;
identifying, within the end attachment text entry, at least one unique entry, and/or identifying, within the end attachment text entry, a pre-set unique entry;
wherein, when only one unique entry is identified that matches the heading text entry, a database query is generated that contains at least an attachment text entry with an end attachment text entry embedded, in which the unique entry that matches the heading text entry has been identified, and/or contains a unique identifier of this attachment text entry.

2. The method of claim 1, characterized in that web content is identified using a hyperlink associated with the heading text entry.

3. The method of claim 2, characterized in that a graphical user interface is generated that provides at least
a data entry area, and
a first interactive element, which, when interacted with, generates and sends a query that contains the hyperlink or its part to a database,
wherein the hyperlink or its part are generated based on data entered in the data entry area.

4. The method of claim 3, characterized in that the generated graphical user interface provides a reply area containing a generated reply to the database query in the form of a text entry containing at least one entry stored in the database.

5. The method of claim 4, characterized in that the reply in the form of a text entry contains a heading text entry.

6. The method of claim 4, characterized in that the generated graphical user interface provides a second interactive element, which, when interacted with, generates a control signal to store at least some part of the reply in the form of a text entry in a memory of a user device and/or a server.

7. The method of claim 5, characterized in that the generated graphical user interface provides a second interactive element, which, when interacted with, generates a control signal to store at least some part of the reply in the form of a text entry in a memory of a user device and/or a server.

8. The method of claim 6, characterized in that the generated graphical user interface provides a third interactive element, which, when interacted with, generates an XML file that contains at least the reply in the form of a text entry or its part stored in the memory of a user device and/or a server,
wherein the third interactive element is available only when the reply in the form of a text entry or its part is stored in the memory of a user device and/or a server.

9. The method of claim 7, characterized in that the generated graphical user interface provides a third interactive element, which, when interacted with, generates an XML file that contains at least the reply in the form of a text entry or its part stored in the memory of a user device and/or a server,
wherein the third interactive element is available only when the reply in the form of a text entry or its part is stored in the memory of a user device and/or a server.
